(19) United States
(12) Patent Application Publication
(10) Pub. No.: US 2026/0265157 A1
(43) Pub. Date: Sep. 10, 2026

(54) SOIL REGULATION DISPERSIBLE GRANULES

(71) Applicant: PHOSPHOLUTIONS INC., State College, PA (US)

(72) Inventors: Pauline WELIKHE, Bellefonte, PA (US); Kyle J. ISAACSON, Bradenton, FL (US); Stephan LEVITSKY, State College, PA (US); Aaron WALTZ, Rockford, IL (US); Hunter SWISHER, St. Peterburg, FL (US)

(21) Appl. No.: 18/871,847

(22) PCT Filed: Jun. 7, 2023
(86) PCT No.: PCT/US2023/024686

§ 371 Date: Dec. 5, 2024

Related U.S. Application Data
(60) Provisional application No. 63/350,176, filed on Jun. 8, 2022.

(51) Int. Cl. C05G 5/12; C05D 9/02; C05G 3/60

(52) U.S. Cl. CPC C05G 5/12; C05D 9/02; C05G 3/60

(57) ABSTRACT

Soil regulation dispersible granules are disclosed including at least one metal oxide domain and at least one nutrient domain. The at least one metal oxide domain and the at least one nutrient domain are present in the soil regulation dispersible granules as distinct domains clustered together. The soil regulation dispersible granules are free of phosphorus. Further soil regulation dispersible granules are disclosed in which the at least one metal oxide domain includes at least one metal oxide selected from the group consisting of alumina, α-alumina, β-alumina, γ-alumina, δ-alumina, bauxite, alumina trihydrate, alumina monohydrate, boehmite, pseudoboehmite, gibbsite, diaspore, and combinations thereof, and the at least one nutrient domain includes a nutrient selected from the group consisting of bioavailable species of molybdenum, selenium, zinc, copper, cobalt, iron, nickel, manganese, vanadium, calcium, potassium, sulfur, chlorine, silicon, magnesium, sodium, nitrogen, boron, and combinations thereof.

### RELATED APPLICATIONS

This application claims the benefit of and priority to U.S. Provisional Patent Application No. 63/350,176, filed Jun. 8, 2022, entitled “Soil Regulation Dispersible Granules,” which is hereby incorporated by reference in its entirety.

### FIELD OF THE INVENTION

This application is directed to soil regulation dispersible granules. In particular, this application is directed to soil regulation dispersible granules having metal oxides and nutrients and being free of phosphorus.

### BACKGROUND OF THE INVENTION

In agricultural systems, ensuring that crops have access to adequate plant nutrient supplies is essential to maximizing yields. Soil systems, however, are imperfect in providing nutrients to plants through their root systems, and many plant nutrients are unavailable for plant uptake as they are tied up with soil particles, carried away via surface runoff, or leached into subterranean waterways. To combat undesired nutrient-soil outcomes, agriculturalists often aim to improve the cation and anion exchange capacities of their soils to ensure a dynamic ionic environment.

Sulfur is an essential plant nutrient that is almost exclusively taken up by plant roots as sulfate (SO₄²⁻). While sulfur is generally abundant in soils with adequate organic matter, many common soil conditions ensure that only a small fraction of the sulfur remains in a soluble, plant-available form. In general, sulfur is cycled between organic and inorganic forms via mobilization, immobilization, mineralization, oxidation, and reduction processes. Of the two forms, inorganic sulfur is more mobile with sulfate (SO₄²⁻) being the most mobile ion. Sulfate mobility in soils is constrained by sorption processes, wherein adsorption and desorption are predominantly controlled by sulfate concentration in soil solution, soil pH, the character of colloidal surfaces, and the presence of other anions in solution. Isotope studies show that sulfate ions in soil solution are in kinetic equilibrium with sulfate ions adsorbed to the soil solid phase. The adsorption of sulfate is pH-dependent, wherein maximum adsorption is reached at a pH of 3 and rapidly decreases as the pH increases, becoming negligible at pH values greater than 6.5. Additionally, sulfate is considered weakly adsorbed to soil, with anions such as OH⁻ and H₂PO₄⁻ outcompeting sulfate for adsorption sites.

In recent decades, sulfur deficiency has been recognized as a limiting factor on crop production all over the world. The reduction of sulfur dioxide emissions and the regular use of high-analysis low sulfur-containing fertilizers are among the reasons for observed sulfur deficiencies in crops. To manage sulfur deficiencies, several inorganic sulfur fertilizers (e.g., ammonium sulfate, ammonium thiosulfate, potassium sulfate, magnesium sulfate, and others) are applied to agricultural soils. The sulfate in sulfur fertilizers has the advantage of being immediately available for uptake by plant roots following dissolution. However, this relatively large dose of sulfate released to the soil solution over a short period of time is mostly leached down the soil profile beyond the root zone of plants. Many current sulfur fertilizer formulations aim to create a slow-release sulfur system. These systems generally involve manipulation of the sulfur solubility kinetics by altering the chemical form of the sulfur or by using granular coatings to delay sulfur entrance into the soil solution phase. While such measures prevent the immediate increase in sulfur availability occasionally observed when using standard sulfur fertilizers, these measures do not provide sulfur to the soil solution phase during times of high crop need or store sulfur during times of low crop need. An optimally sulfur-buffered agricultural soil would match sulfur availability to crop needs via rhizosphere-responsive sulfur sorption behavior.

A relatively recent type of commercial soil amendment, activated alumina, regulates soil levels of available phosphorus via a pH-dependent and concentration-dependent sorption mechanism. However, this sorption-based buffering capability has not been considered or applied for the management of other anionic plant nutrients.

### BRIEF DESCRIPTION OF THE INVENTION

In one exemplary embodiment, soil regulation dispersible granules include at least one metal oxide domain and at least one nutrient domain. The at least one metal oxide domain and the at least one nutrient domain are present in the soil regulation dispersible granules as distinct domains clustered together. The soil regulation dispersible granules are free of phosphorus.

In another exemplary embodiment, soil regulation dispersible granules include at least one metal oxide domain and at least one nutrient domain. The at least one metal oxide domain includes at least one metal oxide selected from the group consisting of alumina, α-alumina, β-alumina, γ-alumina, δ-alumina, bauxite, alumina trihydrate, alumina monohydrate, boehmite, pseudoboehmite, gibbsite, diaspore, and combinations thereof. The at least one nutrient domain includes a nutrient selected from the group consisting of bioavailable species of molybdenum, selenium, zinc, copper, cobalt, iron, nickel, manganese, vanadium, calcium, potassium, sulfur, chlorine, silicon, magnesium, sodium, nitrogen, boron, and combinations thereof. The at least one metal oxide domain and the at least one nutrient domain are present in the soil regulation dispersible granules as distinct domains clustered together. The soil regulation dispersible granules are free of phosphorus.

### BRIEF DESCRIPTION OF THE DRAWINGS

These and other features, aspects, and advantages of the present subject matter will become better understood when the following detailed description is read with reference to the accompanying drawings in which:

FIG. 1 is a cross-sectional schematic view of a coherent dispersible granule, according to an embodiment of the present disclosure.

FIG. 2 is a graphic comparison of corn yield (bushels/acre) in 2021 for various aluminum oxide levels (lbs/acre) for (A) poultry litter treatments; (B) granular MAP treatments; and (C) powder MAP treatments.

FIG. 3 is a graphic comparison of corn and soy yield (bushels/acre) in 2022 for various aluminum oxide levels (lbs/acre) for (A) poultry litter treatments; (B) granular MAP treatments; and (C) powder MAP treatments.

FIG. 4 is a graphic comparison of corn earleaf sulfur concentration (%) in 2021 for various aluminum oxide levels (lbs/acre) for (A) poultry litter treatments; (B) granular MAP treatments; and (C) powder MAP treatments.

FIG. 5 is a graphic comparison of corn and soy earleaf sulfur concentration (%) in 2022 for various aluminum oxide levels (lbs/acre) for (A) poultry litter treatments; (B) granular MAP treatments; and (C) powder MAP treatments.

FIG. 6 is a graphic comparison of corn earleaf aluminum concentration (%) in 2021 for various aluminum oxide levels (lbs/acre) for (A) poultry litter treatments; (B) granular MAP treatments; and (C) powder MAP treatments.

FIG. 7 is a graphic comparison of corn and soy earleaf aluminum concentration (%) in 2022 for various aluminum oxide levels (lbs/acre) for (A) poultry litter treatments; (B) granular MAP treatments; and (C) powder MAP treatments.

FIG. 8 is a graphic comparison of soil sulfur concentration (ppm) in 2021 for various aluminum oxide levels (lbs/acre) for (A) 0-3 inch soil depth; (B) 3-6 inch soil depth; and (C) 6-12 inch soil depth.

FIG. 9 is a graphic comparison of soil sulfur concentration (ppm) in 2022 for various aluminum oxide levels (lbs/acre) for (A) 0-3 inch soil depth; (B) 3-6 inch soil depth; and (C) 6-12 inch soil depth.

FIG. 10 is a graphic comparison of soil aluminum concentration (ppm) in 2021 for various aluminum oxide levels (lbs/acre) for (A) 0-3 inch soil depth; (B) 3-6 inch soil depth; and (C) 6-12 inch soil depth.

FIG. 11 is a graphic comparison of soil aluminum concentration (ppm) in 2022 for various aluminum oxide levels (lbs/acre) for (A) 0-3 inch soil depth; (B) 3-6 inch soil depth; and (C) 6-12 inch soil depth.

FIG. 12 is a graphic comparison of soil Mehlich-3-aluminum concentration (ppm) in 2021 for various aluminum oxide levels (lbs/acre) for (A) 0-3 inch soil depth; (B) 3-6 inch soil depth; and (C) 6-12 inch soil depth.

FIG. 13 is a graphic comparison of soil Mehlich-3-aluminum concentration (ppm) in 2022 for various aluminum oxide levels (lbs/acre) for (A) 0-3 inch soil depth; (B) 3-6 inch soil depth; and (C) 6-12 inch soil depth.

FIG. 14 is a graphic comparison of sulfur release into a distilled water reservoir over time from ammonium sulfate granules versus co-granulated aluminum oxide and ammonium sulfate granules.

Whenever possible, the same reference numbers will be used throughout the drawings to represent the same parts.

### DETAILED DESCRIPTION OF THE INVENTION

Disclosed herein are soil regulation dispersible granules having metal oxides and nutrients that are free of phosphorus. Embodiments of the present disclosure, in contrast to granules lacking one or more of the features disclosure herein, have greater production efficiency, greater granule crush strength, less intergranular variability in metal oxide: nutrient weight ratio, improved interaction between metal oxide and nutrient domains, improved metal oxide surface area and activity, reduced moisture content, greater hygroscopic stability, or combinations thereof. These soil regulation dispersible granules may adsorb and desorb anionic plant nutrients, such as sulfur, molybdenum, nitrogen, boron, and chlorine, and curtail their release rate. Uninterrupted supply of anionic nutrients may improve overall plant health and reduce the need for plants to allocate energy for these nutrients. The reduced energy needs promote excess energy to be applied to other plant needs, improving other plant characteristics and behaviors, such as cationic nutrient uptake.

Certain anions exhibit pH-dependent adsorption and desorption behavior to metal oxides. The co-addition of metal oxides to fertilizers may promote the ability of crops to access anionic plant nutrients, leading to less plant stress and reduced allocation of energy needs to nutrient acquisition. In turn, these crop benefits enable improvements in cationic nutrient uptake, as the increased plant energy reserves may be shifted toward such activities. On a per acre basis, fertilizer needs may be reduced, improving the sustainability profile of agricultural activities. With reduced fertilizer use, runoff and leaching may be reduced, global fertilizer supplies may be extended, and the lifetimes of fertilizer mines may be increased.

As used herein, “about” indicates a variance of up to 10% from the value being so modified. All values modified with “about” are also intended to convey the unmodified value as an alternative, so that “about 10 μm,” by way of examples, discloses both a range of 9-11 μm as well as specifically 10 μm.

As used herein, “free of phosphorus” indicates that no phosphorus is present other than trace incidental impurities at a concentration too low to have any material effect on the properties or behavior of the soil regulation dispersible granules. The maximum level of such trace incidental impurities for phosphorus is a P₂O₅ level of less than 1.0%, by weight.

As used herein, “coherent” dispersible granules are differentiated from typical agglomerated dispersible granules in that “agglomerated” refers to granules formed by mechanically agglomerating at least two types of preformed particles together, whereas “coherent” refers to granules formed by clustering one type of preformed particle with a second domain of material which is being simultaneously formed. Structural distinctions between coherent dispersible granules and agglomerated dispersible granules include, but are not limited to, granule crush strength, resistance to attrition, moisture content, hygroscopic stability, intergranular variability in metal oxide: nutrient weight ratio, contact surface area between metal oxide and nutrient domains resulting in tighter adhesion, metal oxide surface area, binder incorporation, degree of intermixed domains, or combinations thereof.

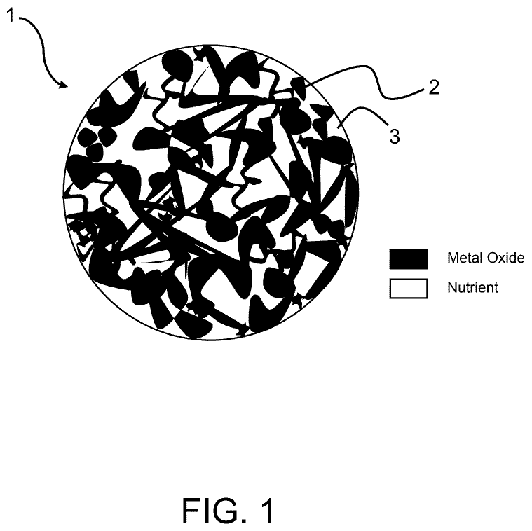

Referring to FIG. 1, in one embodiment, soil regulation dispersible granules 1 include at least one metal oxide domain 2 and at least one nutrient domain 3. The at least one metal oxide domain 2 and the at least one nutrient domain 3 are present in the soil regulation dispersible granules 1 as distinct domains clustered together. The soil regulation dispersible granules 1 are free of phosphorus. The proportion of anionic plant nutrient adsorption onto metal oxides of the soil regulation dispersible granules 1 may be increased relative to an otherwise identical comparative soil regulation composition having intermingled (but not co-granulated) metal oxide particles and nutrient particles due to improved soil placement proximity of metal oxide and nutrient in the soil regulation dispersible granules 1 as compared to the comparative soil regulation composition.

The presence of the at least one metal oxide domain 2 in the soil regulation dispersible granules 1 along with the at least one nutrient domain 3 may slow the release of the at least one nutrient from the soil regulation dispersible granules 1. In one embodiment, aluminum oxide as the at least one metal oxide domain 2 reduces the rate of release from the soil regulation dispersible granules 1 of sulfur from ammonium sulfate as the at least one nutrient domain 3.

The soil regulation dispersible granules 1 may be agglomerated dispersible granules or coherent dispersible granules (FIG. 1). Coherent dispersible granules may have reduced intergranular metal oxide: nutrient weight ratio variability compared to agglomerated dispersible granules, alternatively 5% less intergranular metal oxide: nutrient weight ratio variability, alternatively 10% less, alternatively 15% less, alternatively 20% less, alternatively 25% less. In one embodiment, coherent dispersible granules have an intergranular variability in metal oxide: nutrient weight ratio of ±40%, alternatively ±35%, alternatively ±30%, alternatively ±25%, alternatively ±20%, alternatively ±15%. As used herein, intergranular variability is measured relative to the lesser component of metal oxide and nutrient as measured by the average across the coherent dispersible granules such that if the average metal oxide: nutrient weight ratio is 50:50 with an intergranularity of ±40%, the metal oxide: nutrient weight ratio may range from 30:70 to 70:30. By way of further explanation, if the average metal oxide: nutrient weight ratio is 25:75 with an intergranularity of ±40%, the metal oxide: phosphate weight ratio may range from 15:85 to 35:65.

The coherent dispersible granules may have a greater coherent dispersible granule crush strength than the agglomerated dispersible granules. In one embodiment, the coherent dispersible granules have a coherent dispersible granule crush strength of at least 3 lbf, alternatively at least 3.5 lbf, alternatively at least 4 lbf, alternatively at least 4.5 lbf, alternatively at least 5 lbf. Crush strength is measured by placing a granule on a steel surface and slowly bringing more weight/pressure on the granule until it cracks/breaks (procedure IFDC S-115 in the Manual for Determining Physical Properties of Fertilizer).

The at least one metal oxide domain 2 and the at least one nutrient domain 3 of the soil regulation dispersible granules 1 may be intragranularly homogenously or heterogeneously distributed in the soil regulation dispersible granules 1. The at least one metal oxide domain 2 and the at least one nutrient domain 3 of the soil regulation dispersible granules 1 may be intergranularly homogenously or heterogeneously distributed in the soil regulation dispersible granules 1.

In one embodiment, each of the at least one metal oxide domain 2 is at least 50% surrounded by the at least one nutrient domain 3, alternatively at least 60% surrounded, alternatively at least 70% surrounded, alternatively at least 80% surrounded, alternatively at least 90% surrounded, alternatively at least 95% surrounded, alternatively at least 99% surrounded, alternatively entirely surrounded. Degree of surrounding may be measured by energy dispersive x-ray spectroscopy combined with scanning electron microscopy.

The dispersible granules 1 may include at least one of a water-soluble binder, a suspension agent, or an emulsifying agent. In one embodiment, the dispersible granules 1 include, by weight, 1-40% water-soluble binder, alternatively 5-35%, alternatively 5-15%, alternatively 10-20%, alternatively 15-25%, alternatively 20-30%, alternatively 25-35%, or any sub-range or combination thereof. Suitable water-soluble binders include, but are not limited to, calcium lignosulfonate, ammonium lignosulfonate, or combinations thereof. Suitable suspension agents include, but are not limited to, polysaccharides, inorganic salts, carbomers, or combinations thereof. Suitable emulsifying agents include, but are not limited to, vegetable derivatives such as acacia, tragacanth, agar, pectin, carrageenan, or lecithin, animal derivatives such as gelatin, lanolin, or cholesterol, semi-synthetic agents such as methylcellulose, or carboxymethylcellulose, synthetics such as benzalkonium chloride, benzethonium chloride, alkali soaps (including sodium or potassium oleate), amine soaps (including triethanolamine stearate), detergents (including sodium lauryl sulfate, sodium dioctyl sulfosuccinate, or sodium docusate), sorbitan esters, polyoxyethylene derivatives of sorbitan esters, glyceryl esters, or combinations thereof.

The soil regulation dispersible granules 1 may further include at least one additional domain present as a distinct domain. The at least one additional domain may include at least one pesticide domain, at least one biological additive domain, or combinations thereof. The at least one additional domain may be clustered with the at least one metal oxide domain 2 and the at least one nutrient domain 3 via mechanical or coherent agglomeration, may be coated onto the soil regulation dispersible granules 1, intermixed with the soil regulation dispersible granules 1, or combinations thereof.

Suitable at least one pesticide domains include, but are not limited to, herbicides, insecticides, fungicides, nematicides, or combinations thereof. Suitable herbicides include, but are not limited to, sulfonylureas, HPPD-inhibitors, chloroacetamides, PPO-inhibitors, phenylurea, triazines, or combinations thereof. Suitable insecticides include, but are not limited to, organophosphates, carbamides, pyrethrins, neonicotinoids, spinosins, indoxacarb, diamides, or combinations thereof. Suitable fungicides include, but are not limited to, strobilurines, pyrimidines, triazoles, dicarboximides, or combinations thereof. Suitable nematicides include, but are not limited to, avermectin, carbamates, organophosphates, or combinations thereof.

Suitable at least one biological additive domains include, but are not limited to, at least one additive selected from the group consisting of humics, fulvics, living microbes, microbial metabolites, plant extracts, exogenous plant hormones, and combinations thereof. Any suitable variations of humic or fulvic acid-containing formulations or any materials of which are organic matter derived and contain numerous humic and/or fulvic acid species may be employed. Microbes may include, but are not limited to, Rhodopseudomonas spp., Bacillus spp., Pseudomonas spp., Saccharomyces spp., Aspergillus spp., Candida spp., Streptococcus spp., Lactobacillus spp., or combinations thereof. Plant extracts may include, but are not limited to, phytohormones, quinols, plastoquinones, flavonoids, plant-growth-promoting metabolites, or combinations thereof. Exogenous plant hormones may include, but are not limited to, IDAA, gibberellin, abscisic acid, auxins, jasmonates, brassinosteroids, cytokinins, salicylic acid, or combinations thereof.

The dispersible granules 1 may further include mineral particles. The mineral particles may be mechanically or coherently agglomerated in the dispersible granules 1, agglomerated with the dispersible granules 1, or intermixed with the coherent dispersible granules 1.

In one embodiment, the dispersible granules 1 include, by weight, 5-80% metal oxide domain, 10-95% nutrient domain, and, optionally, 1-50% water-soluble binder, alternatively 30-40% metal oxide domain, 30-40% nutrient domain, and 20-40% water-soluble binder, alternatively 35% metal oxide domain, 35% nutrient domain, and 30% water-soluble binder. In a further embodiment, the coherent dispersible granules 1 include by weight, 5-70% metal oxide domain, 10-70% nutrient domain, up to 50% water-soluble binder, and up to 20% surfactants and emulsifiers combined, alternatively consist of, by weight, 5-50% metal oxide domain, 10-50% nutrient domain, up to 50% water-soluble binder, and up to 5% surfactants and emulsifiers combined.

The dispersible granules 1 may have any suitable size (as measured by diameter based upon the median within the sample). Suitable sizing for the dispersible granules 1 may include, but is not limited to, about 0.4 mm to about 4.0 mm, alternatively about 0.4 mm to about 1.2 mm, alternatively about 0.9 mm to about 1.5 mm, alternatively about 1.2 mm to about 1.8 mm, alternatively about 1.5 mm to about 2.1 mm, alternatively about 1.8 mm to about 2.4 mm, alternatively about 2.1 mm to about 2.7 mm, alternatively about 2.4 mm to about 3.0 mm, alternatively about 2.7 mm to about 3.3 mm, alternatively about 3.0 mm to about 3.6 mm, alternatively about 3.3 mm to about 4.0 mm, alternatively about 0.4 mm, alternatively about 0.5 mm, alternatively about 0.6 mm, alternatively about 0.7 mm, alternatively about 0.8 mm, alternatively about 0.9 mm, alternatively about 1.0 mm, alternatively about 1.1 mm, alternatively about 1.2 mm, alternatively about 1.3 mm, alternatively about 1.4 mm, alternatively about 1.5 mm, alternatively about 1.6 mm, alternatively about 1.7 mm, alternatively about 1.8 mm, alternatively about 1.9 mm, alternatively about 2.0 mm, alternatively about 2.1 mm, alternatively about 2.2 mm, alternatively about 2.3 mm, alternatively about 2.4 mm, alternatively about 2.5 mm, alternatively about 2.6 mm, alternatively about 2.7 mm, alternatively about 2.8 mm, alternatively about 2.9 mm, alternatively about 3.0 mm, alternatively about 3.1 mm, alternatively about 3.2 mm, alternatively about 3.3 mm, alternatively about 3.4 mm, alternatively about 3.5 mm, alternatively about 3.6 mm, alternatively about 3.7 mm, alternatively about 3.8 mm, alternatively about 3.9 mm, alternatively about 4.0 mm, alternatively more than about 4.0 mm, or any sub-range or combination thereof. In one non-limiting example, golf greens may use dispersible granules of about 0.5 mm to about 0.8 mm. In another non-limiting example, corn may use dispersible granules 1 via a broadcast application of about 2.4 mm. In a third non-limiting example, any crop with a strip-till machine application may use dispersible granules 1 of about 1.5 mm. In one embodiment, suitable, for example, for application as a suspension, the dispersible granules 1 are micronized, and have a particle size less than about 200 μm, alternatively less than about 150 μm, alternatively less than about 100 μm, alternatively less than about 75 μm, alternatively less than about 50 μm, alternatively less than about 25 μm, alternatively less than about 10 μm, alternatively less than about 5 μm, alternatively less than about 2 μm, alternatively less than about 1 μm, alternatively less than about 0.75 μm, alternatively less than about 0.5 μm, alternatively less than about 0.25 μm, alternatively less than about 0.1 μm, alternatively less than about 0.05 μm, alternatively less than about 0.01 μm, as measured by largest particle dimension.

The metal oxide of the at least one metal oxide domain 2 may include activated metal oxide. The metal oxide may be activated via calcination, acid treatment, or combinations thereof.

The metal oxide of the at least one metal oxide domain 2 may be any suitable metal oxide, including, but not limited to, alumina, α-alumina, β-alumina, γ-alumina, δ-alumina, bauxite, alumina trihydrate, alumina monohydrate, boehmite, pseudoboehmite, gibbsite, diaspore, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, and zinc oxide, or combinations thereof. As used herein, “metal oxide” is understood to be inclusive of metal oxide hydrates and metal oxide hydroxides.

The nutrients of the at least one nutrient domain 3 may be any suitable nutrients, including, but not limited to, bioavailable species of molybdenum, selenium, zinc, copper, cobalt, iron, nickel, manganese, vanadium, calcium, potassium, sulfur, chlorine, silicon, magnesium, sodium, nitrogen, boron, or combinations thereof. Bioavailable species of the foregoing nutrients include, but are not limited to, MoO₂⁻, SeO₂⁻, Zn²⁺, ZnCl⁻, CuCO₃, Co²⁺, Fe²⁺, Fe³⁺, Ni²⁺, NiCl⁺, Mn²⁺, MnCl⁺, HVO₄²⁻, Ca²⁺, K+, SO₄²⁻, Cl⁻, SiOH₄, Mg²⁺, Na⁺, NH⁴⁺, NO₃⁻, H₃BO₃, and B₄O₇²⁻.

The weight ratio of metal oxide: nutrient in the soil regulation dispersible granules may be any suitable weight ratio, including, but not limited to, a weight ratio of 10:1 to 1:10, alternatively 8:1 to 1:8, alternatively 7:1 to 1:7, alternatively 6:1 to 1:6, alternatively 5:1 to 1:5, alternatively 4:1 to 1:4, alternatively 3:1 to 1:3, alternatively 2:1 to 1:2, alternatively 3:1 to 1:1, alternatively 1:1 to 1:3, alternative about 2:1, alternatively about 1:1, alternatively about 1:2, or any sub-range or combination of ranges thereof.

The metal oxide domains 2 may have any suitable size. In one embodiment, to maintain adsorptive capacity for nutrient and optimize size for penetrating the soil profile through a surface application, a preferred size for metal oxide domains 2 is smaller than about 300 μm, alternatively smaller than about 150 μm, alternatively smaller than about 100 μm, alternatively smaller than about 75 μm, alternatively smaller than about 50 μm, alternatively smaller than about 25 μm, or smaller, or any sub-range or combination thereof.

The soil regulation dispersible granules 1 may be co-applied as a soil regulation agent with plant nutrient fertilizers to fields or co-granulated with one or more plant nutrients into a single complex granule and applied to fields. The soil regulation dispersible granules 1 may be employed as soil buggers for nutrients rather than as soil amendments. The soil regulation dispersible granules 1 may be used as both a soil amendment and as a granular fertilizer formulation, by way of example, in cost-prohibitive markets such as agriculture or forestry.

### EXPERIMENTAL

In a first study (Study 1), the potential of metal oxides to affect or regulate other nutrients than phosphorus was unexpectedly demonstrated. In a second study (Study 2), the combination of a metal oxide with ammonium sulfate into a single granule was examined.

### Study 1: Non-Phosphorus Nutrient Regulation by Metal Oxides

The effect of a one-time single broadcast no-till application of aluminum oxide on nutrient uptake in corn was tested in State College Pennsylvania in a split-plot trial design for two subsequent years. A full factorial of four poultry litter application rates (0 tons/acre, 2 tons/acre, 4 tons/acre, and 6 tons/acre) and 4 aluminum oxide application rates (0 lb/acre, 600 lb/acre, 1,200 lb/acre, 2,400 lb/acre) were performed (16 treatments total) and replicated 4 times each. Both the poultry litter and aluminum oxide applications were performed a single time in the spring of 2021, yet the effects on crop yield, soil characteristics, and crop nutrient uptake were measured in both the 2021 and 2022 fall seasons.

Two additional experiments were conducted simultaneously, where monoammonium phosphate (“MAP”) was applied onto the plots in place of poultry litter, one with granular MAP and one with MAP powder. In these trials, corn was the investigated crop in 2021, and soybean was rotated and tested on the fields in 2022.

### Soil Sampling and Analysis

At the beginning of the season, two soil samples were obtained for each plot: one representing the top 0-6 inches of soil and the other representing the soil at a depth of 6-12 inches. At the end of each growing season, three soil samples were collected: one representing the soil at a depth of 0-3 inches, one representing the 3-6 inch depth, and one representing the 6-12 inch depth. The Soil Mehlich 3-S was performed on all soil samples to measure available sulfur concentrations within the soil. Additionally, both total and available aluminum (Soil Mehlich-3-Al) concentrations were measured on all samples to gauge whether aluminum oxide application increased the adverse effects of aluminum ion toxicity on soils. Soil Mehlich 3 tests were performed via an acid extraction of the soil that combines acetic acid (CH₃COOH), ammonium nitrate (NH₄NO₃), ammonium fluoride (NH₄F), nitric acid (HNO₃) and ethylenediaminetetraacetic acid (EDTA) at pH 2.5. These tests were performed at contract research laboratories and determined via ion conductivity plasma mass spectroscopy.

### Corn Tissue Sampling

A crop tissue earleaf sampling was obtained from representative plants from each plot after the corn had reached an R3 stage in both the 2021 and 2022 growing seasons. Both sulfur and aluminum content were measured in each sample.

### Results

The results of the study indicated that aluminum oxide application increased yield on corn in the year of application with no detrimental effects on yield the following season. Aluminum oxide application increased retention of sulfur throughout multiple growing seasons by reducing sulfur leaching through the soil. This increased sulfur retention led to greater sulfur uptake in the crop, even an entire season after application. Despite aluminum oxide application increasing the total aluminum concentrations of soil following application, no significant effect was observed on increasing ionic aluminum concentrations in the soil. Without being bound by theory, it is believed that the lack of significant effect from increasing ionic aluminum concentrations in the soil was likely due to the inherently chemically-stable structure of aluminum oxide and other metal oxides.

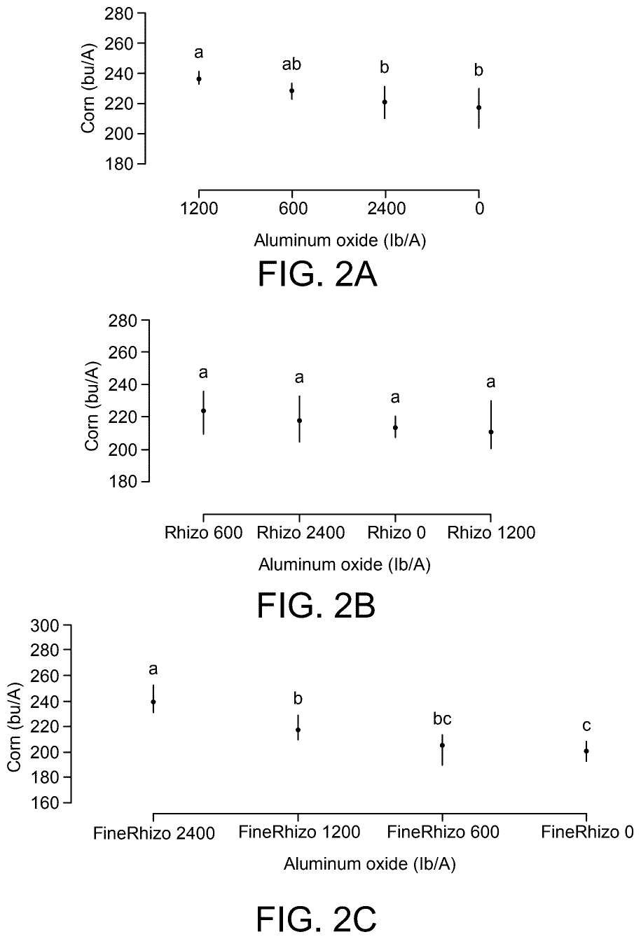

Referring to FIG. 2, with respect to corn yield at various aluminum oxide application rates along with (A) poultry litter treatments, (B) granular MAP treatments, and (C) powder MAP treatments, measured in 2021, means associated with the same plot did not differ statistically. The numerical and statistical differences between those plots receiving aluminum oxide application treatments and those receiving no aluminum oxide application rate indicated that aluminum oxide positively affected corn yield.

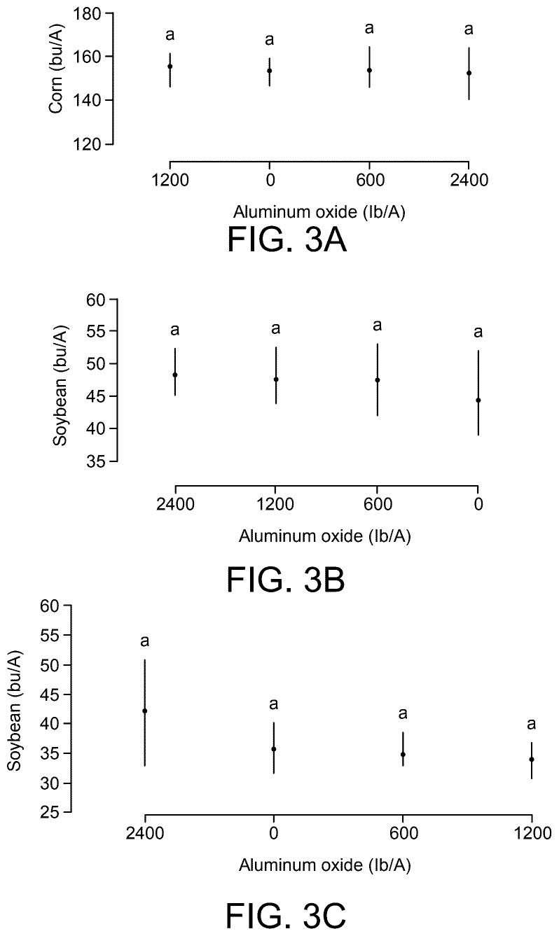

Referring to FIG. 3, with respect to corn yield at various aluminum oxide application rates along with (A) poultry litter treatments, (B) granular MAP treatments, and (C) powder MAP treatments, measured in 2022 following the treatments in 2021, means associated with the different treatments did not differ statistically. The lack of statistical difference between treatments one year following indicated that there was no season-after-season corn yield effect from a bulk application of aluminum oxide.

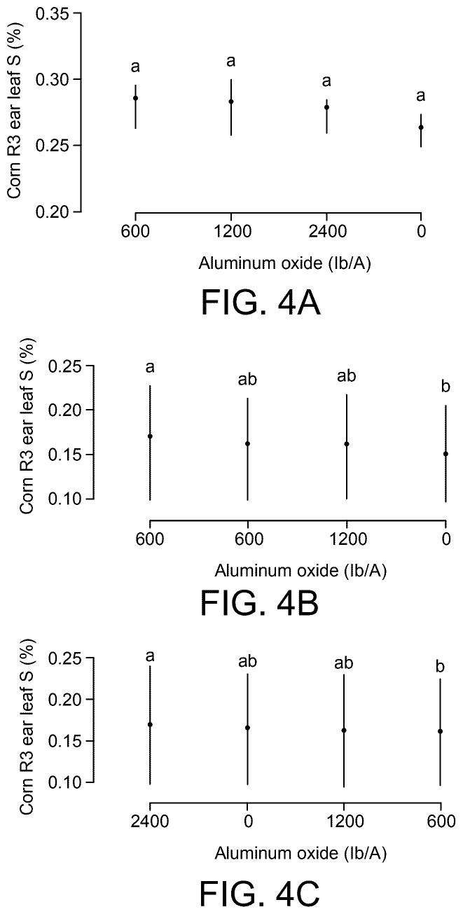

Referring to FIG. 4, with respect to R3 corn earleaf sulfur concentrations at various aluminum oxide application rates along with (A) poultry litter treatments, (B) granular MAP treatments, and (C) powder MAP treatments, measured in 2021, means associated with the same plot did not differ statistically. The numerical and statistical differences between the plots indicated that aluminum oxide application increased sulfur uptake in corn.

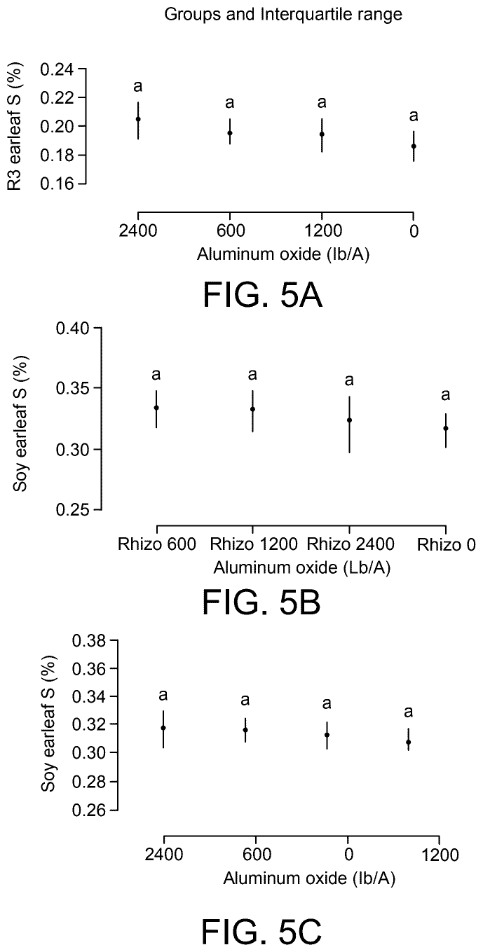

Referring to FIG. 5, with respect to R3 corn earleaf sulfur concentrations at various aluminum oxide application rates along with (A) poultry litter treatments, (B) granular MAP treatments, and (C) powder MAP treatments, measured in 2022 following the treatments in 2021, means associated with the different treatments did not differ statistically. The lack of statistical differences between the different treatments one year following indicate that aluminum oxide application had minimal season-to-season effect on sulfur uptake in corn.

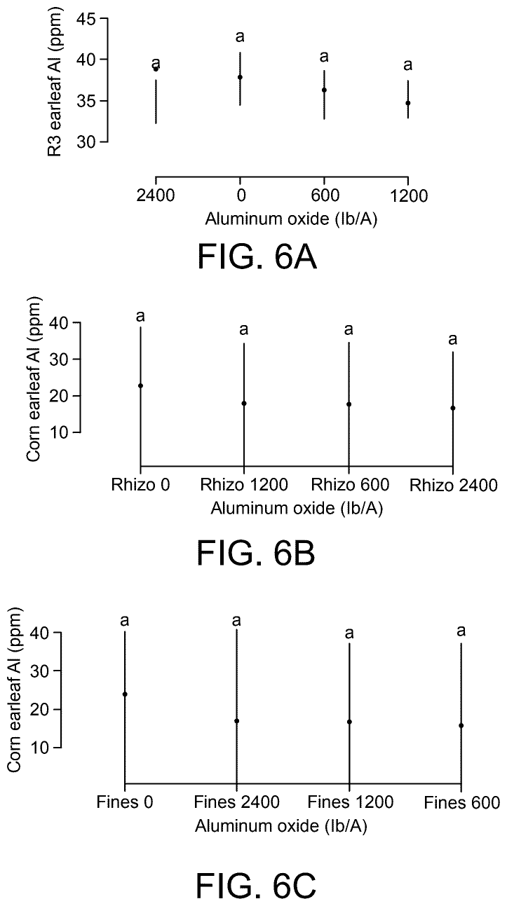

Referring to FIG. 6, with respect to R3 corn earleaf aluminum concentrations at various aluminum oxide application rates along with (A) poultry litter treatments, (B) granular MAP treatments, and (C) powder MAP treatments, measured in 2021, means associated with the different treatments did not differ statistically. The lack of statistical differences between the different treatments showed that no change in aluminum uptake was observed despite a large bulk aluminum oxide application.

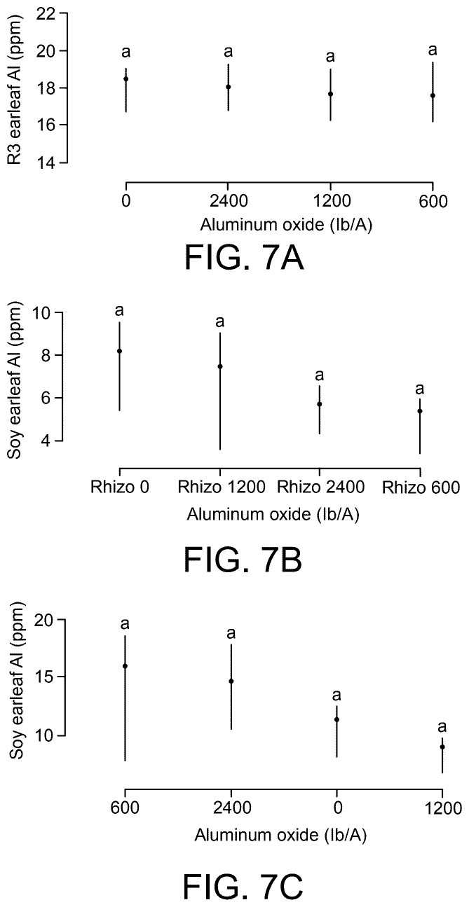

Referring to FIG. 7, with respect to R3 corn earleaf aluminum concentrations at various aluminum oxide application rates along with (A) poultry litter treatments, (B) granular MAP treatments, and (C) powder MAP treatments, measured in 2022 following the treatments in 2021, means associated with the different treatments one year later did not differ statistically. The lack of statistical differences between the groups showed that no change in aluminum uptake was observed despite a large bulk aluminum oxide application in the previous growing season.

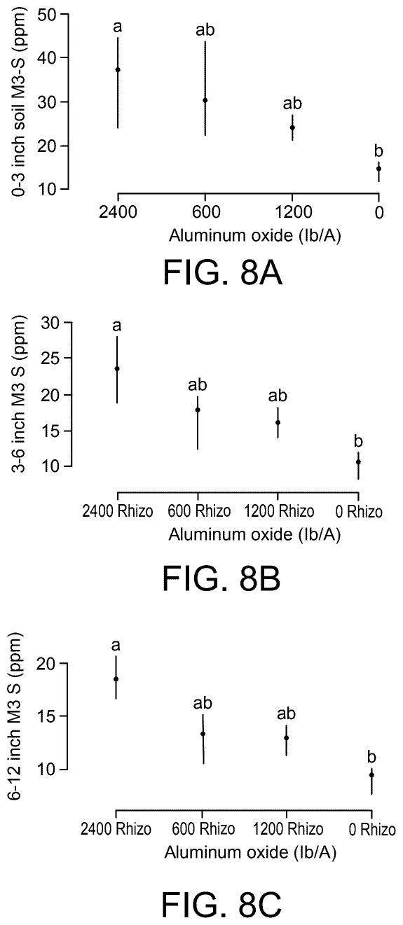

Referring to FIG. 8, with respect to corn soil sulfur concentrations at various aluminum oxide application rates along with (A) 0-3 inch soil depth, (B) 3-6 inch soil depth, and (C) 6-12 inch soil depth, measured in 2021, means associated with the same plot did not differ statistically. The statistical difference between those pots receiving aluminum oxide application treatments and those not receiving any aluminum oxide application indicated that aluminum oxide reduced soil sulfur leaching throughout the growing season.

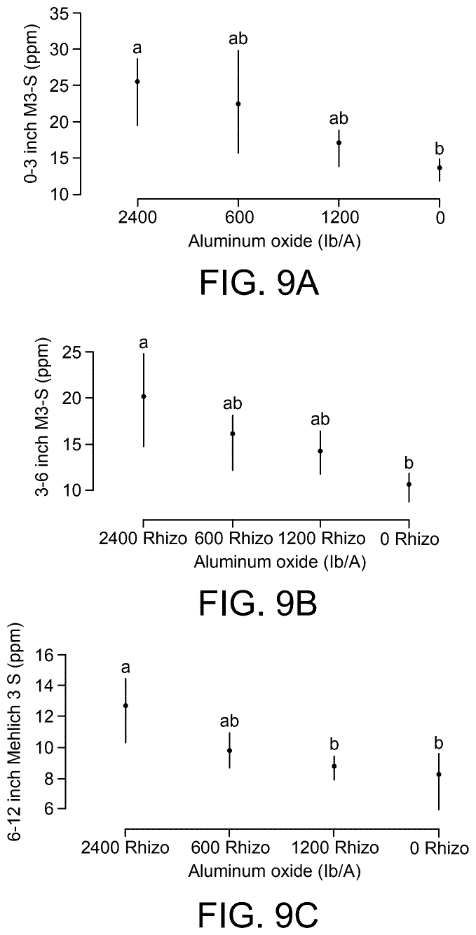

Referring to FIG. 9, with respect to corn soil sulfur concentrations at various aluminum oxide application rates along with (A) 0-3 inch soil depth, (B) 3-6 inch soil depth, and (C) 6-12 inch soil depth, measured in 2022 following the treatments in 2021, means associated with the same letter did not differ statistically. The statistical difference between those plots receiving aluminum oxide application treatments and those not receiving any aluminum oxide application indicated that aluminum oxide successfully reduced soil sulfur leaching throughout the 2021 growing season and promoted greater soil sulfur concentrations throughout the 2022 growing season.

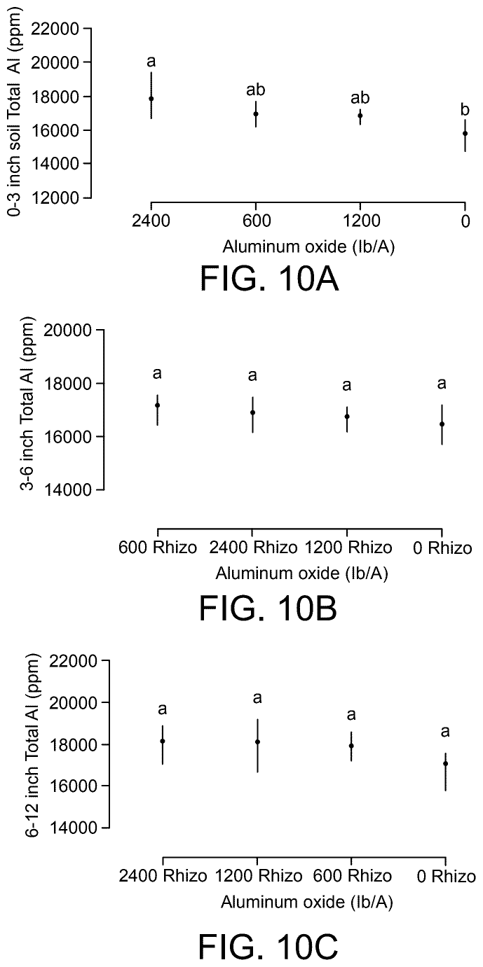

Referring to FIG. 10, with respect to corn soil aluminum concentrations at various aluminum oxide application rates along with (A) 0-3 inch soil depth, (B) 3-6 inch soil depth, and (C) 6-12 inch soil depth, measured in 2021, means associated with the same plot did not differ statistically. The numerical difference between those plots receiving aluminum oxide application treatments and those not receiving any aluminum oxide application indicated that adding aluminum oxide to a soil increased the concentration of aluminum in that soil.

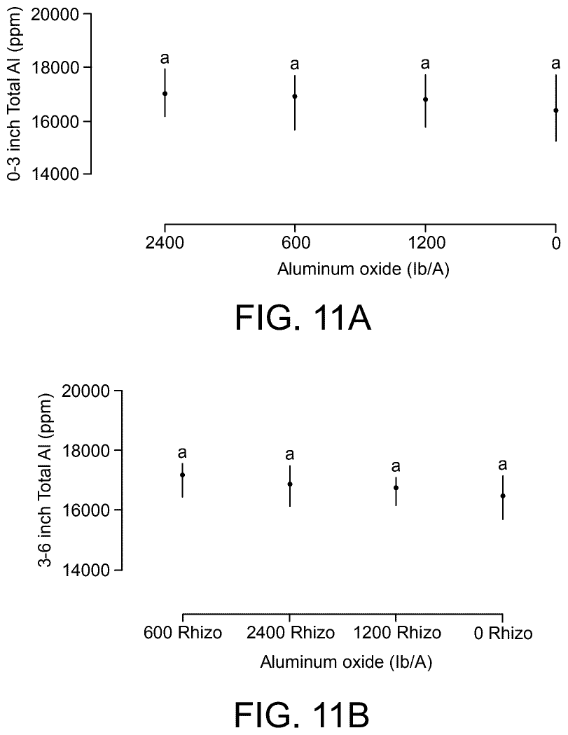

Referring to FIG. 11, with respect to corn soil aluminum concentrations at various aluminum oxide application rates along with (A) 0-3 inch soil depth, (B) 3-6 inch soil depth, and (C) 6-12 inch soil depth, measured in 2022 following the treatments in 2021, means associated with the same plot did not differ statistically. Though not significant, the numerical difference between those plots receiving aluminum oxide application treatments and those not receiving any aluminum oxide application indicated that adding aluminum oxide to a soil increased the concentration of aluminum in that soil, even one year following application.

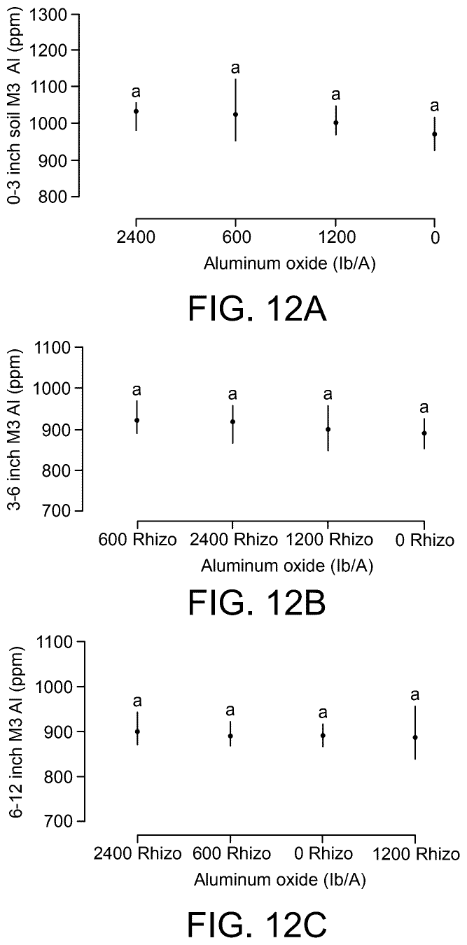

Referring to FIG. 12, with respect to corn soil Mehlich-3-aluminum concentrations at various aluminum oxide application rates along with (A) 0-3 inch soil depth, (B) 3-6 inch soil depth, and (C) 6-12 inch soil depth, measured in 2021, means associated with the same letter did not differ statistically. The lack of statistical difference between those plots receiving aluminum oxide application treatments and those not receiving any aluminum oxide application showed that no discernible increase in ionic aluminum concentrations could be observed, despite the increase in soil total aluminum concentrations.

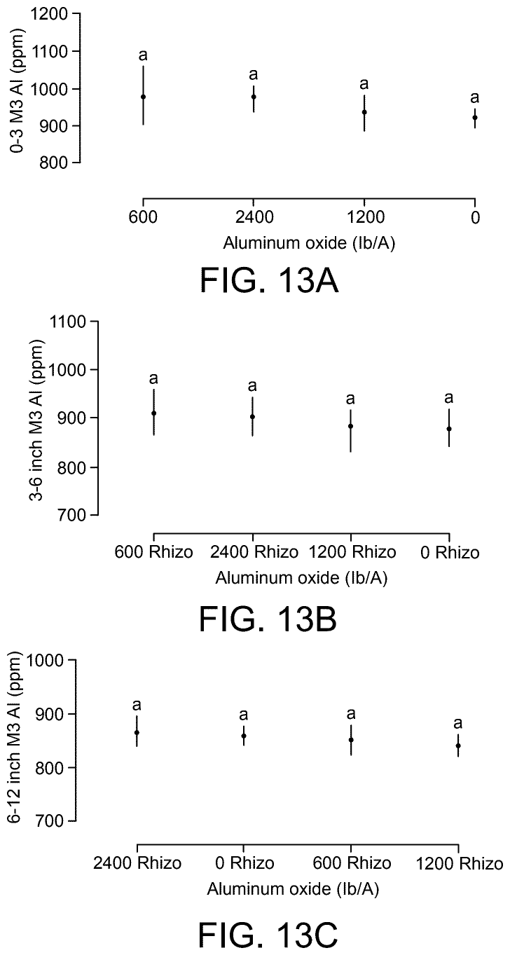

Referring to FIG. 13, with respect to corn soil Mehlich-3-aluminum concentrations at various aluminum oxide application rates along with (A) 0-3 inch soil depth, (B) 3-6 inch soil depth, and (C) 6-12 inch soil depth, measured in 2022 following the treatments in 2021, means associated with the same plot did not differ statistically. The lack of statistical difference between those plots receiving aluminum oxide application treatments and those not receiving any aluminum oxide application showed that no discernible increase in ionic aluminum concentrations could be observed the following growing season after application, despite the increase in soil total aluminum concentrations.

### Study 2: Combination of a Metal Oxide with Ammonium Sulfate into a Single Granule

Aluminum oxide powder (−100 US Mesh) was co-granulated with ammonium sulfate (21-0-0-24S NPKS) powder at a 1:1 aluminum oxide: ammonium sulfate weight ratio using ammonium lignosulfonate binder to create a 9-0-0-10S NPKS product. The sulfur release curves were obtained by placing a designated weight of granules (0.3 g of sulfur) into 50 mL of deionized water and monitoring sulfate concentrations in the water reservoir at designated time points. Aliquots of liquid were removed and replaced from the liquid reservoir at periodic time points. Sulfate concentrations in the aliquots were measured spectrophotometrically by following the protocols outlined in the EPA-165-C Rev. 2A Method for the Determination of Sulfate to determine sulfate release. This method involved the use of barium chloride and a suspension agent to allow concentrations to be measured turbidimetrically.

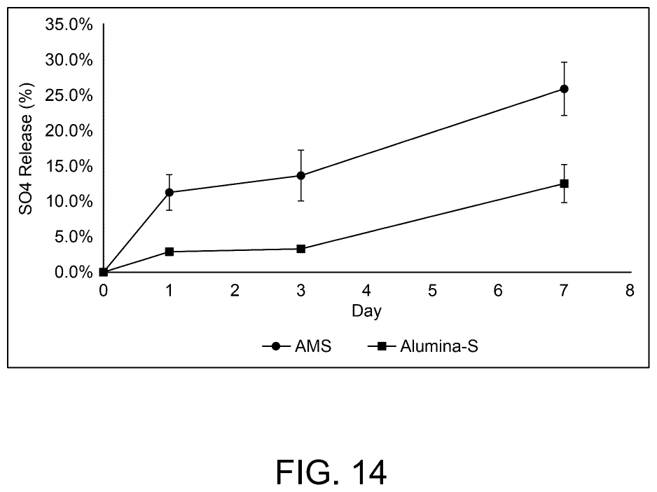

Referring to FIG. 14, the release of sulfur over time from ammonium sulfate (“AMS”) granules and co-granulated aluminum oxide and ammonium sulfate (“Alumina-S”) granules demonstrates that incorporation of aluminum oxide controlled the release of sulfur, extending the release over a longer time period.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. Soil regulation dispersible granules, comprising:
at least one metal oxide domain; and
at least one nutrient domain,
wherein:
the at least one metal oxide domain and the at least one nutrient domain are present in the soil regulation dispersible granules as distinct domains clustered together; and
the soil regulation dispersible granules are free of phosphorus.

2. The soil regulation dispersible granules of claim 1, wherein the soil regulation dispersible granules are coherent dispersible granules.

3. The soil regulation dispersible granules of claim 2, wherein the coherent dispersible granules have an intergranular variability in metal oxide: nutrient weight ratio of ±40% and a coherent dispersible granule crush strength of at least 3 lbf.

4. The soil regulation dispersible granules of claim 1, wherein the at least one metal oxide domain includes an activated metal oxide domain.

5. The soil regulation dispersible granules of claim 1, wherein the at least one metal oxide domain includes at least one metal oxide selected from the group consisting of alumina, α-alumina, β-alumina, γ-alumina, δ-alumina, bauxite, alumina trihydrate, alumina monohydrate, boehmite, pseudoboehmite, gibbsite, diaspore, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, zinc oxide, and combinations thereof.

6. The soil regulation dispersible granules of claim 5, wherein the at least one metal oxide domain includes the metal oxide selected from the group consisting of alumina, α-alumina, β-alumina, γ-alumina, δ-alumina, bauxite, alumina trihydrate, alumina monohydrate, boehmite, pseudoboehmite, gibbsite, diaspore, and combinations thereof.

7. The soil regulation dispersible granules of claim 6, wherein the at least one metal oxide domain further includes at least one additional metal oxide selected from the group consisting of iron oxide, hematite, maghemite, magnetite, goethite, iron hydroxide, and combinations thereof.

8. The soil regulation dispersible granules of claim 7, wherein the at least one metal oxide domain further includes at least one additional metal oxide selected from the group consisting of calcium oxide, calcium hydroxide, copper oxide, magnesium oxide, manganese oxide, manganese dioxide, nickel oxide, silicon dioxide, zinc oxide, and combinations thereof.

9. The soil regulation dispersible granules of claim 6, wherein the at least one metal oxide domain further includes at least one additional metal oxide selected from the group consisting of calcium oxide, calcium hydroxide, copper oxide, magnesium oxide, manganese oxide, manganese dioxide, nickel oxide, silicon dioxide, zinc oxide, and combinations thereof.

10. The soil regulation dispersible granules of claim 1, wherein the nutrient domain includes a nutrient selected from the group consisting of bioavailable species of molybdenum, selenium, zinc, copper, cobalt, iron, nickel, manganese, vanadium, calcium, potassium, sulfur, chlorine, silicon, magnesium, sodium, nitrogen, boron, and combinations thereof.

11. The soil regulation dispersible granules of claim 10, wherein the nutrient domain includes a bioavailable species of molybdenum.

12. The soil regulation dispersible granules of claim 10, wherein the nutrient domain includes a bioavailable species of sulfur.

13. The soil regulation dispersible granules of claim 1, wherein the at least one metal oxide domain and the at least one nutrient domain are intragranularly homogenously distributed in the soil regulation dispersible granules.

14. The soil regulation dispersible granules of claim 1, wherein the at least one metal oxide domain and the at least one nutrient domain are intergranularly homogenously distributed in the soil regulation dispersible granules.

15. The soil regulation dispersible granules of claim 1, wherein the at least one metal oxide domain is at least 80% surrounded by the at least one nutrient domain.

16. The soil regulation dispersible granules of claim 1, having a metal oxide: nutrient weight ratio ranging from 10:1 to 1:10.

17. The soil regulation dispersible granules of claim 1, further including at least one additional domain present as a distinct domain, wherein the at least one additional domain is selected from the group consisting of at least one pesticide domain, at least one biological additive domain, and combinations thereof.

18. Soil regulation dispersible granules, comprising:
at least one metal oxide domain including at least one metal oxide selected from the group consisting of alumina, α-alumina, β-alumina, γ-alumina, δ-alumina, bauxite, alumina trihydrate, alumina monohydrate, boehmite, pseudoboehmite, gibbsite, diaspore, and combinations thereof; and
at least one nutrient domain including a nutrient selected from the group consisting of bioavailable species of molybdenum, selenium, zinc, copper, cobalt, iron, nickel, manganese, vanadium, calcium, potassium, sulfur, chlorine, silicon, magnesium, sodium, nitrogen, boron, and combinations thereof,
wherein:
the at least one metal oxide domain and the at least one nutrient domain are present in the soil regulation dispersible granules as distinct domains clustered together; and
the soil regulation dispersible granules are free of phosphorus.

19. The soil regulation dispersible granules of claim 18, wherein the at least one metal oxide domain further includes an at least one additional metal oxide selected from the group consisting of iron oxide, hematite, maghemite, magnetite, goethite, iron hydroxide, and combinations thereof.

20. The soil regulation dispersible granules of claim 18, wherein the at least one metal oxide domain is an activated metal oxide domain.
